(19) United States
(12) Patent Application Publication
(10) Pub. No.: US 2010/0152352 A1
(43) Pub. Date: Jun. 17, 2010

(54) SUBSTRATES COATED WITH FLAME RETARDANT COMPOSITIONS BASED ON ORGANIC POLYMERS AND ZEOLITES

(75) Inventors: Don Gary Barber, West Chester, PA (US); Elisabeth S. Papazoglou, Yardley, PA (US)

Correspondence Address: RATNERPRESTIA, P.O. BOX 980, VALLEY FORGE, PA, 19482, US

(73) Assignee: Polymer Products Company, Inc., Stockertown, PA (US)

(21) Appl. No.: 12/635,072

(22) Filed: Dec. 10, 2009

Related U.S. Application Data
(60) Provisional application No. 61/121,232, filed on Dec. 10, 2008.

(51) Int. Cl. C08K 5/12; C08K 3/22; B32B 37/00

(52) U.S. Cl. 524/296; 524/409; 156/60

(57) ABSTRACT

Substrates, which may be either flexible or rigid, are coated with a flame retardant composition containing an organic polymer, a filler and a zeolite. Good flame retardant properties are obtained even where the composition contains low levels of conventional flame retardant additives such as antimony compounds, brominated compounds and zinc compounds. The flame retardant composition may also be used to adhere different substrates together.

### CROSS-REFERENCE TO RELATED APPLICATIONS

This application claims priority from U.S. Provisional Application No. 61/121,232, filed Dec. 10, 2008, incorporated herein by reference in its entirety.

### FIELD OF THE INVENTION

This invention relates to substrates, both flexible and rigid, comprised of or coated with flame-retardant compositions. In particular, this invention relates to flame-retardant compositions based on organic polymers and zeolites that are useful as coatings and adhesives for flexible substrates such as woven and non-woven fabrics, carpets and the like.

### BACKGROUND OF THE INVENTION

Natural and synthetic rubber latexes, polyvinyl acetate latexes, styrenic latexes and acrylic latexes are used in a variety of coating and adhesive applications. In many of these applications, such as textiles, carpeting, paints, clear coatings, adhesives, sealants, caulking, non-woven binders, and a variety of similar applications, the latex-based formulations are required to have smoke suppressant and flame retardant properties in order to help prevent smoke generation and flame spread in the event of a fire. The base polymers in many other cases may be functionalized (e.g., carboxylated or ethoxylated) to achieve the desired properties.

For many woven and non-woven fabrics, it is desirable to apply a backing to the fabric. Backings are applied to carpets, carpet tiles, moldable carpets, liners, covers, mats, moldable mats, rugs, moldable rugs, and other applications. Backings can be used to obtain fiber-lock performance and tuft-lock performance, give stability and structural integrity to the fabric, and afford non-skid characteristics. For example, carpet structures typically have nylon fibers bonded, tufted, or otherwise joined to a primary backing layer, collectively referred to as a face cloth. The face cloth is then bonded to a secondary backing. Such backings can be based on a wide variety of polymers such as polyesters, polyolefins, styrenics or nylon that are capable of imparting the desired support and durability to the carpet structure. In many cases, these backings are also responsible for imparting flammability properties to the carpet structure.

A latex of natural or synthetic rubber or plastisol of polyvinyl chloride (PVC) is often used to formulate the adhesive that bonds the primary and secondary backing layers together. The adhesive, or binder, is typically coated on the reverse side (i.e., the non-pile side) of the primary backing layer, and the primary backing layer and the secondary backing layer pressed together and the carpet passed through an oven to remove water (if present) and cure the adhesive layer.

Although nylon fibers do not support flames or combustion well, heat from a fire can heat or melt the nylon fibers, which in turn can ignite the adhesive layer, providing a sustained flame source and causing the nylon fibers to burn and emit noxious gases. Consequently, adhesives of this type are typically made flame-retardant by blending flame retardant additives together with the latex or plastisol. However, many flame retardant additives contain either bromine compounds or antimony trioxide. For instance, some carpet backings contain brominated compounds, such as decabromobiphenyl oxide (“decabrome”), and/or antimony trioxide. However, brominated compounds add to the cost of these highly cost-sensitive constructions and antimony trioxide has toxicity problems. Additionally, both brominated compounds and antimony trioxide have high specific gravities and thus will increase the specific gravity of an article fabricated using a composition containing such flame retardants, which in many applications is not desirable. Zinc compounds such as zinc borate and zinc oxide are also typically employed as flame retardant additives, especially in PVC-based formulations. However, many zinc-based flame retardants have negative effects on the thermal stability of the polymer composition. Stabilizers do not always overcome the negative effects of such additives. Thus, a need exists for flame-retardant adhesives that do not have these disadvantages. In particular, a need exists for flame-retardant adhesives and coatings based on latexes or plastisols in which the amounts of antimony-, bromine- and/or zinc-containing compounds are reduced or in which the presence of one or more of these types of compounds is completely eliminated, thereby allowing the formulation of improved or “greener” materials with possibly improved costs of manufacture.

Polyvinyl chloride (PVC) is widely used as a component in compositions that are applied as coatings to flexible substrates. In unmodified form, PVC has relatively good flame retardant properties due to its high chloride content. Since PVC by itself is a rigid, inflexible thermoplastic, flexible substrate coating compositions based on PVC are formulated with relatively large amounts of plasticizers to improve the flexibility of the end product. However, the presence of such plasticizers increases the flammability of the final coating obtained from such compositions.

For this reason, various flame retardant and smoke suppressing ingredients are typically incorporated into flexible substrate coating compositions. As is well known, however, it is difficult to simultaneously achieve both adequate flame retardancy and smoke suppression. Compounds that retard flame typically cause incomplete combustion, thereby increasing the amount of smoke generated, while smoke suppressants can function by creating higher heats of combustion to more efficiently consume combustible organic gases. Antimony trioxide, for example, can be an effective flame retardant, but increases the amount of smoke generated in a fire. It would therefore be advantageous to find alternatives to antimony trioxide that retard flame while not contributing to smoke generation.

### SUMMARY OF THE INVENTION

The present invention provides flame retardant compositions useful as coatings for flexible as well as rigid substrates. In one aspect, the invention is an article which comprises:

a substrate, which can be rigid or flexible and which can have at least one surface, wherein the at least one surface can have at least a partial coating of a flame retardant composition thereon;

the flame retardant composition comprising, consisting essentially of, or consisting of:

at least one organic polymer, which may be a halogenated or non-halogenated organic polymer;

at least one zeolite;

at least one filler, which may optionally include at least one active filler;

optionally, at least one antimony compound, brominated compound, and/or zinc compound;

optionally, at least one plasticizer;

optionally, at least one stabilizer;

in which:

the total amount of active filler, antimony compound, brominated compound, zinc compound and zeolite in the composition is less than or equal to about 50 phr; and

the ratio of the total weight of the antimony compound, brominated compound and zinc compound to the weight of the zeolite is in a range from 0 to 10.

In one aspect of the invention, the composition is free of antimony compounds and/or brominated compounds and/or zinc compounds. In another aspect, the invention is a carpet comprising tufted fibers attached to a primary backing layer, an adhesive layer attached to the primary backing layer, and a secondary backing layer attached to the adhesive layer, wherein the adhesive layer comprises the flame retardant composition of the invention. In still another aspect, the flexible substrate and the flame retardant composition are selected such that the resulting coated flexible substrate remains flexible (i.e., the flame retardant composition coating does not render the substrate inflexible).

### DETAILED DESCRIPTION OF CERTAIN EMBODIMENTS OF THE INVENTION

Parts per hundred resin (phr) refers to parts of additive per one hundred parts of base polymer. Unless the context indicates otherwise, in the specification and claims the terms zeolite, organic polymer, plasticizer, stabilizer, filler, antimony compound, brominated compound, zinc compound and similar terms also include mixtures of such materials. The terms filler, flame retardant, stabilizer and smoke suppressant do not include zeolites or ion-exchanged zeolites. Unless otherwise specified, all percentages are percentages by weight and all temperatures are in degrees Centigrade (degrees Celsius).

In one aspect, the invention involves replacing all or a portion of the antimony compound(s) in a flame retardant composition with zeolite. The flame retardant compositions thereby obtained are particularly useful as adhesives to bind together the primary and secondary backings of carpets.

### Substrate

The substrate may be flexible or inflexible (rigid), but in one embodiment of the invention is in the form of a knit, woven or non-woven fabric, i.e., a thin, flexible material made of any combination of cloth, fiber, polymeric film, sheet or foam. The fabric may be a woven, knitted or non-woven fabric based on, for example, fibers comprised of a synthetic polymer such as a polyolefin (e.g., polyethylene, polypropylene), a polyester (e.g., polyethylene terephthalate), or polyamide, a natural polymer such as cellulose or cotton, or even an inorganic substance such as glass. The substrate may also be in the form of a paper, e.g., a felted or matted sheet of cellulose fibers. Biodegradable polymers may also be used to fabricate the substrate. The substrate may be a layer of a single substance or have a multilayer structure, where the individual layers are comprised of different materials. Rubbers and elastomers, which may be in solid, foamed or fibrous form, may also be utilized to provide suitable flexible substrates.

Rigid substrates may be constructed of any suitable material, but in one embodiment of the invention the rigid substrate is comprised of an inflexible thermoplastic or thermoset (crosslinked) material, which can be in solid, foamed or other form. Such materials are well known in the art and include, for example, epoxies, polyesters (including unsaturated polyesters), polyurethanes, polyacrylates, polycarbonates, polyethers, polystyrenes, polyolefins, PVC (and other vinyl polymers), which can be admixed or formulated with other components such as fillers, reinforcing agents, pigments, stabilizers and the like. The rigid substrate may also be a cellulosic material such as wood, plywood, particle board, chip board, fiberboard, cardboard, or the like or a metallic material such as steel, aluminum, alloys or the like. Additionally, composites or laminates can be utilized as the substrate.

### Flame Retardant Composition

### Organic Polymer

The organic polymer can be a natural organic polymer, a modified natural organic polymer, or a synthetic organic polymer. In one embodiment, the organic polymer is a rubber (elastomer), such as a thermoplastic elastomer or cross-linked rubber. In certain embodiments of the invention, the organic polymer is a halogenated organic polymer, but in other embodiments is a non-halogenated organic polymer.

In one advantageous embodiment of the invention, the organic polymer is initially in the form of a latex, i.e., a suspension or dispersion of particles of the organic polymer in an aqueous medium. As is well known in the art, the latex may contain other components such as surfactants and water soluble polymers that assist in keeping the organic polymer particles stably dispersed. Typically, such a latex contains from 30 to 80% by weight of the organic polymer.

In another advantageous embodiment of the invention (particularly where the organic polymer is a relatively rigid, high melting halogenated organic polymer such as PVC), the organic polymer is initially in the form of a plastisol, i.e., a suspension or dispersion of particles of the organic polymer in a plasticizer medium (a volatile solvent may also be present).

The use of such a latex or plastisol can assist in providing a coating composition that can be more readily applied to a substrate by techniques such as spraying, dipping, brushing, roller coating, knife coating, blade coating, rod coating, extrusion coating and so forth. Once the coating composition has been applied to the substrate surface, the water or other volatile materials originally present in the latex may be removed by heating, for example, thereby drying the coating composition and causing the organic polymer particles to fuse together. Where the organic polymer is initially in the form of a plastisol, heating the coating results in “curing” of the organic polymer (for example, rigid PVC is transformed to a rubberlike material).

Suitable halogenated polymers include, but are not limited to, polyvinyl chloride (PVC), chlorinated polyvinyl chloride (CPVC), polychloroprene (neoprene), acrylonitrile-vinyl chloride copolymers, vinyl chloride-vinyl acetate copolymers, polyvinylidene chloride, tetrafluoroethylene-vinyl chloride copolymers, and polyfluoro-chloro ethylene polymers. In one embodiment, the halogenated organic polymer is a rigid (inflexible) thermoplastic that is capable of being plasticized to form a relatively soft, rubbery composition.

In one embodiment of the invention, the organic polymer is a natural or synthetic rubber, which may be supplied in the form of a latex. Illustrative examples of rubbers (elastomers) suitable for use as the organic polymer component of the present invention include natural rubber (predominately cis-1,4-polyisoprene), polyisoprene rubber, butadiene rubber, chloroprene rubber, nitrile-butadiene rubber, ethylene-propylene (EPM) rubber, ethylene-propylene-diene (EPDM) rubber, acrylic elastomers (rubbery polymers and copolymers in which esters of acrylic acid such as ethyl acrylate and butyl acrylate constitute a large portion of the monomers used to prepare the polymer), butyl rubber, and particularly styrene-butadiene rubber (SBR). SBR may be prepared by emulsion polymerization of styrene and butadiene to obtain a random copolymer, with the amount of bound styrene typically ranging from about 15 to about 65 weight percent.

Natural polymers and modified natural polymers include, for example, cellulose and modified celluloses such as cellulose acetate, carboxymethyl cellulose, ethyl cellulose, ethyl hydroxyethyl cellulose, hydroxypropyl cellulose, hydroxypropylmethyl cellulose, methyl cellulose, methyl ethyl cellulose, and cross-linked carboxymethyl cellulose.

Biodegradable polymers include, for example, lactic acid-based polymers and copolymers, polyalkylene esters, polyamide esters, polyvinyl esters and polyanhydrides.

Additional examples of suitable synthetic organic polymers include those disclosed, for example, in Kaprinidis, U.S. Pat. No. 7,109,260, column 3, line 50, to column 7, line 30, the disclosure of which is incorporated herein by reference in its entirety. Synthetic polymers include, for example, polyamides, polyvinyl polymers, and polyolefins.

The organic polymer can comprise a polyamide or copolyamide derived from a diamine and a dicarboxylic acid and/or from an aminocarboxylic acid or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).

The organic polymer can comprise a polyolefin or a mixture of polyolefins. These are polymers and copolymers of mono-olefins and di-olefins such as ethylene, propylene, 1-butenene, 1-octene, iso-butylene, butadiene, and isoprene. Polymers of mono-olefins and di-olefins, for example polypropylene, polyisobutylene, polybut-1-ene, poly-4-methylpent-1-ene, polyvinylcyclohexane, polyisoprene or polybutadiene, as well as polymers of cyclo-olefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE). Mixtures of polyolefins include, for example, mixtures of polypropylene with polyisobutylene, polypropylene with polyethylene and mixtures of different types of polyethylene. Copolymers of mono-olefins and di-olefins with each other or with other vinyl monomers, include, or example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cyclo-olefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylenepropylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.

The organic polymer can comprise a polymer or a copolymer of a vinyl aromatic monomer such as styrene or poly-α-methyl styrene, such as polystyrene, poly-α-methyl styrene, or styrene/acrylonitrile.

Suitable polyesters include, for example, thermoplastic polyesters such as poly(alkylene) terephthalates, e.g., PET and PBT, as well as other polymers capable of being prepared by condensation of diacids and diols.

In one embodiment of the invention, the organic polymer employed in the flame retardant composition is predominately or entirely a non-halogenated organic polymer or mixture of non-halogenated organic polymers. For example, the flame retardant composition may contain less than 10 parts by weight or less than 5 parts by weight or less than 1 parts by weight halogenated organic polymer per 100 parts by weight non-halogenated organic polymer or may even be free of any halogenated organic polymer.

In another embodiment of the invention, the organic polymer employed in the flame retardant composition is predominately or entirely a halogenated organic polymer or mixture of halogenated organic polymers. For example, the flame retardant composition may contain less than 10 parts by weight or less than 5 parts by weight or less than 1 parts by weight non-halogenated organic polymer per 100 parts by weight halogenated organic polymer or may even be free of any non-halogenated organic polymer.

### Zeolites

Zeolites are natural or synthetic microporous crystalline inorganic compounds with three dimensional structures and generally contain silicon, aluminum, and oxygen in their framework and loosely held cations, water and/or other molecules in their pores. More particularly, zeolites are aluminosilicates comprised of interlocking tetrahedrons of SiO₄ and AlO₄. The SiO₄ and AlO₄ structural elements impart a net negative charge to the pores that are responsible for holding the cations inside the pores and permits these cations to be readily exchanged with other cations.

In the present invention, the zeolite functions as a flame retardant, as a synergist in cooperation with other types of flame retardants that may be present in the flame retardant composition, and also as a smoke suppressant. These characteristics permit the flame retardant composition to be formulated with reduced amounts of conventional synergists such as antimony compounds, as compared to conventional flame retardant compositions, while still maintaining good flame retardancy properties and reducing the amount of smoke generated by the composition when ignited.

Natural zeolites are aluminosilicates that can be represented by the general formula:

M_{a/n}O[(Al₂O₃)_{b}(SiO₂)_{c}].xH₂O

where M is a metal ion such as Na⁺, K⁺, Ca⁺², or Mg⁺²; n is the valence of the metal ion M; a, b, c, and x are positive integers, where the ratio a:n=2 and the ratio c:b is between 1:1 and 5:1. An example is the natural zeolite, natrolite, which has the structure:

Na₂O[(Al₂O₃)(SiO₂)₃].2H₂O.

The aluminosilicate structure is negatively charged and attracts the positive cations that reside within. When exposed to higher charged ions of a new element, zeolites will exchange the lower charged ions contained within the zeolite for the higher charged ions of the new element.

Examples of natural zeolites include: clinoptilolite (hydrated sodium, potassium, calcium aluminosilicate); analcime or analcite (hydrated sodium aluminum silicate); chabazite (hydrated calcium aluminum silicate); harmotome (hydrated barium potassium aluminum silicate); heulandite (hydrated sodium calcium aluminum silicate); laumontite (hydrated calcium aluminum silicate); mesolite (hydrated sodium calcium aluminum silicate); natrolite (hydrated sodium aluminum silicate); phillipsite (hydrated potassium sodium calcium aluminum silicate); scolecite (hydrated calcium aluminum silicate); stellerite (hydrated calcium aluminum silicate); stilbite (hydrated sodium calcium aluminum silicate); and thomsonite (hydrated sodium calcium aluminum silicate). Natural zeolites suitable for use in the present invention are available from many commercial sources, including Zeo, Inc. of McKinney, Tex.

Synthetic zeolites can be made by slow crystallization of silica-alumina gels in the presence of alkalis and organic templates. The exact composition and structure of the product formed depend on the composition of the reaction mixture, pH of the medium, operating temperature, reaction time, and the template used.

Commercially available zeolites include several products of Nippon Chemical, sold as the “Zeostar’ zeolites, including: Zeostar CA-100P and Zeostar CA-110P; Zeostar CX-100P and Zeostar CX-110P; Zeostar KA-100P and Zeostar KA-110P; Zeostar NA-100P and NA-110P; and Zeostar NX-100P and Zeostar NX-110P; and the VALFOR® zeolites and ADVERA® zeolites, such as VALFOR® 100 sodium aluminosilicate hydrated type Na-A zeolite powder and ADVERA® 401/401P hydrated sodium zeolite A (PQ Corp., Valley Forge, Pa.).

Zeolites useful in the invention can either be a natural, synthetic, or a mixture thereof. The zeolite can be untreated or surface treated with such materials as higher fatty acids and their salts such as stearic acid, oleic acid, and salts of stearic acid and oleic acid, or salts of higher alkyl-, aryl-, or alkylaryl-sulfonic acids such as of dodecylbenzenesulfonic acid or the like. The zeolite may be calcined or uncalcined. Calcining may carried out at 200° C. to 700° C. for a period of 1-10 hours, typically at 300° C. to 500° C. for a period of 2-5 hours.

The zeolite may also be an ion-exchanged zeolite, that is, a zeolite composition in which the alkali metal ions and/or alkaline earth ions of the aluminosilicate structure have been at least partially replaced by another metal ion. Typical metal ions that may be used include cations of V, Mo, Mn, Fe, Co, Ni, Cu, Zn, Sb, B, and mixtures thereof.

Ion-exchanged zeolites may be produced by stirring a mixture of the zeolite in an aqueous solution containing a water-soluble salt of the desired metal. In certain instances, it is preferable to stir the zeolite in a concentrated solution of sodium chloride in order to exchange sodium for the difficulty released potassium, calcium, and magnesium ions and then to effect further exchange of the sodium ions in a solution of the desired metal ion. The exchange may be carried out at about 20° C. to about 100° C., typically at about 40° C. to about 80° C.

Although adducts of zeolites and inorganic halides have been employed as components of self-extinguishing polymeric compositions (see U.S. Pat. No. 5,149,735, incorporated herein by reference in its entirety), in preferred embodiments of this invention the flame retardant composition does not contain such adducts.

Preferably, the zeolite is incorporated into the flame retardant composition in the form of finely divided particles, where the average particle size may be, for example, less than 100 microns or less than 50 microns or even less than 10 microns.

Typically, the flame retardant composition will be comprised of at least 1 phr or at least 2 phr zeolite. However, in at least certain types of formulations useful within the scope of the present invention, it has been found that even relatively low levels of zeolite can be surprisingly effective in improving the flame retardant properties of the composition. Thus, in certain embodiments of the invention, the composition contains not more than 10 or not more than 5 phr of zeolite.

### Plasticizers

In one embodiment of the invention, one or more plasticizers, sometimes known as flexibilizers or flexibilizing agents, are incorporated into the flame retardant composition to increase its flexibility, especially where the organic polymer employed is a polyvinyl chloride. Examples of suitable plasticizers include phthalate esters, phosphate esters, adipate esters, and sebacate esters. Typical phthalate esters are dimethyl phthalate (DMP), diethyl phthalate (DEP), dibutyl phthalate (DBP), dihexyl phthalate (DHP), di-2-ethylhexyl phthalate (DOP), diisodecyl phthalate (DIDP), butylbenzyl phthalate (BBP), diisononyl phthalate (DINP), and dinonyl phthalate (DNP). Typical adipate esters are dioctyl adipate (DOA) and diisodecyl adipate (DIDA). Typical sebacate esters are dibutyl sebacate (DBS) and dioctyl sebacate (DOS). Of these examples, phthalate ester plasticizers are especially advantageous. They may be used alone or in combination with one another.

Triaryl phosphates, such as triphenyl phosphate and tricresyl phosphate (TCP), are suitable plasticizers that also help to greatly enhance the flame retardant properties of the coating and adhesive compositions used in the present invention. Alkyl diphenyl phosphates and alkyl diaryl phosphates retain most of the flame retardant characteristics of triaryl phosphates, but produce significantly less smoke. SANTICIZER® 2148 (Ferro, Cleveland, Ohio USA), an alkyl diaryl phosphate with very low volatility, is an example of a particularly suitable plasticizer.

Halogenated plasticizers, including chlorinated plasticizers and brominated plasticizers, may be used as plasticizers. Chlorinated polyethylene (CPE), prepared by chlorination of polyethylene and typically comprising about 22 wt % to 60 wt % chlorine, is a suitable halogenated plasticizer. Brominated plasticizers offer slight plasticizing effects but their halogen content provides extra flame retardancy. Examples of brominated plasticizers include brominated di-octyl phosphate and a tetrabromophthalate ester (bis(2-ethylhexyl)tetrabromophthalate) sold under the trade names DP-45 (Great Lakes, West Lafayette, Ind. USA) and Uniplex FRP-45 (Unitex Chemical, Greensboro). Other plasticizers include: polymeric plasticizers, such as ethylene/acrylate/carbon monoxide terpolymers, for example ELVALOY® HP-441 (DuPont, Wilmington, Del. USA); fatty acid esters of pentaerythritol, such as HERCOFLEX 707 and HERCOFLEX 707A (Hercules, Wilmington Del.); alkyl trimellitates, such as PX-336, a trialkyl ester of 1,2,4-benzene tricarboxylic acid (trimellitic acid); and diesters of aliphatic diacids, such as dioctyl sebacate.

Depending on the base polymer used in the composition and the intended application, the flame retardant composition used in the present invention may or may not comprise a plasticizer. When present, the plasticizer or mixture of plasticizers can, in certain embodiments, be present in the flame retardant composition in an amount of at least about 20 phr, at least about 30 phr, or at least 40 phr and not more than about 100 phr, not more about 90 phr, or not more than about 80 phr.

### Antimony Compounds

Antimony compounds, such as antimony tetroxide, antimony pentoxide, sodium antimonate, antimony tartrate, and especially antimony trioxide act as synergists, increasing the performance of halogenated flame retardants to lower the heat release rate and inhibit flame propagation. However, not only is antimony toxic, it contributes to smoke release and at certain levels may be antagonistic to phosphate plasticizers. Because zeolites have been found to act as effective flame retardants as well as smoke suppressants, the level of antimony compounds in the composition may be reduced when a zeolite or a mixture of zeolites is incorporated into the flame retardant composition to be utilized as a coating or adhesive. In certain embodiments of the invention, the total amount of antimony compound and zeolite in the composition is less than or equal to about 8 phr, less than or equal to about 6 phr, or less than or equal to about 4 phr. The ratio of the weight of the antimony compound to the weight of the zeolite can, in certain embodiments, be 0 to about 1.25, 0 to about 1.2, 0 to about 1.1, or 0 to about 1.0.

### Fillers

The flame retardant composition used as a coating or adhesive in the present invention further comprises a filler or a mixture of fillers. Typical fillers are inorganic particulate fillers such as metal oxides, particularly hydrated metal oxides such as hydrated aluminum oxide (alumina trihydrate, Al₂O₃.3H₂O), magnesium hydroxycarbonate and magnesium hydroxide. These materials are active fillers, providing the normal benefits of a filler along with additional flame retardation upon thermal decomposition. Other types of inorganic particulate fillers such as magnesium oxide, calcined koalin clay, talc, and metal carbonates (such as calcium carbonate and magnesium carbonate), although not flame-retardant per se and thus not regarded as active fillers, may be employed to help reduce the spread of flaming droplets. The composition may comprise about 10 to about 100 phr of a filler or a mixture of fillers. The term fillers as used herein does not include zeolites or antimony compounds or zinc compounds.

### Halogenated Organic Flame Retardant Compounds

In one embodiment of the present invention, the flame retardant composition is comprised of one or more halogenated organic flame retardant compounds (especially brominated compounds), although in other embodiments the flame retardant composition is free of such compounds. The halogenated organic flame retardant compound in one embodiment is non-polymeric, e.g., a non-polymeric brominated organic flame retardant compound. Halogenated organic flame retardant compounds are well known in the art and are compounds that have an inhibitory effect on the ignition of combustible organic materials, including polymers, for example, thermoplastic polyolefins. More particularly, the halogenated organic flame retardant compounds are halogenated compounds that release hydrogen halide upon undergoing thermal degradation. The hydrogen halide, in turn, reacts with highly reactive H and OH radicals that are produced by a burning fuel, for example, a burning organic polymer. The reaction between the hydrogen halide and the H and OH radicals produces inactive H₂O molecules and halogen radicals. Since halogen radicals have a much lower energy state than H or OH radicals, the potential for propagating the radical oxidation reaction (that is, the fire) is lowered.

Any halogenated organic compound that functions as a flame retardant can be used in the composition of the present invention, particularly chlorinated organic compounds, brominated organic compounds, and chlorinated/brominated organic compounds. Examples of such halogenated organic compounds include halogenated aryls, for example, halogenated benzenes, biphenyls, phenols, phenol ethers, phenol esters, bisphenols, diphenyloxides, aromatic carboxylic acids or polyacids, anhydrides, amides or imides thereof; halogenated cycloalkanes or polycycloalkanes; halogenated alkanes, including, for example, halogenated oligomers and polymers thereof; halogenated alkylphosphates; and halogenated alkylisocyanurates. Non-polymeric halogenated organic compounds are used as flame retardant in one embodiment of the invention.

Preferably, the halogenated organic flame retardant compound comprises bromine. Preferred brominated compounds include brominated cycloalkanes and brominated aryls, for example, brominated bisphenols, brominated phenyl ethers, brominated bisphenol carbonate oligomers, brominated bisphenol epoxies, brominated phtalimides, brominated styrenes, and brominated benzenes.

Another class of suitable halogenated organic flame retardant compounds are halogenated organophosphorus flame retardants, including halogenated hydrocarbyl phosphate or phosphonate esters such as tris(tribromoneopentyl) phosphate.

Chlorinated compounds may also be used as the halogenated organic flame retardant compound. Examples of suitable chlorinated organic flame retardant compounds include polychlorinated paraffins.

Examples of particularly preferred halogenated organic flame retardant compounds include decabromodiphenyl oxide, decabromodiphenyl ethane (“decabrome”), 2,3,4,5,6-pentabromoethylbenzene, 1,2-bis(2,4,5-tribromophenoxy)ethane and hexabromocyclododecane.

The use of a halogenated organic flame retardant compound may be desirable when the organic polymer is a non-halogenated polymer. Typically, no halogenated organic flame retardant compound is utilized where a halogenated polymer is selected as the organic polymer component. If present, a halogenated organic flame retardant compound or mixture thereof typically is incorporated into the flame retardant composition at a level of at least 2 phr or 4 phr but not greater than 15 phr or 12 phr.

### Zinc Compounds

In certain embodiments of the invention, the flame retardant composition may optionally contain one or more flame retardant compounds containing zinc. Zinc compounds which act as flame retardants are well known in the art and include, for example, zinc borate, zinc oxide, zinc stannate and the like. Commercially available zinc-containing flame retardants include ONGARD 2, which is said by its supplier (Chemtura) to comprise both magnesium oxide and zinc oxide. If present, a zinc compound or mixture of zinc compounds typically is incorporated into the flame retardant composition at a level of at least 0.1 phr or 0.5 phr but not greater than 5 phr or 3 phr. The ratio of the weight of zinc compound to the weight of zeolite can, in certain embodiments, be 0 to about 1.25, 0 to about 1.2, 0 to about 1.1, or 0 to about 1.0.

### Stabilizers

In order to prevent thermal and oxidative discoloration and brittleness due to the effects of heat and/or light, one or more stabilizers may be added to the flame retardant composition, particularly in the embodiments of the invention where the organic polymer is a halogenated organic polymer such as PVC. Suitable stabilizers include metal-based stabilizers such lead stabilizers, calcium stabilizers, zinc stabilizers, barium stabilizers, magnesium stabilizers, tin stabilizers, as well as so-called mixed metal stabilizers such as calcium/zinc, magnesium/zinc, barium/zinc, and barium/calcium/zinc stabilizers. Organic stabilizers such as epoxidized soy bean oil may also be employed. Exemplary lead stabilizers include basic lead compounds such as tribasic lead sulfate, dibasic lead phosphite, and dibasic lead phosphite sulfite. To enhance the effect of the aforementioned stabilizers, fatty acids and/or fatty acid soaps (e.g., metal soaps such as neutral or basic lead stearate and/or calcium stearate) may be added. The flame retardant composition used in the present invention typically is comprised of 2 to 20 phr of a stabilizer or a mixture of stabilizers, although in other embodiments no stabilizer is incorporated into the flame retardant composition.

### Specific Flame Retardant Composition Embodiments

In one embodiment of the invention, the flame retardant composition is comprised of, consists essentially of, or consists of at least one polyvinyl chloride, 50 to 90 phr (or 60 to 80 phr) of at least one plasticizer, preferably selected from the group consisting of phosphate plasticizers and phthalate plasticizers, 15 to 45 phr (or 20 to 40 phr) of at least one inorganic particulate filler (which may include at least one active filler), preferably selected from the group consisting of calcium carbonate and hydrated metal oxides, 1 to 20 phr (or 5 to 12 phr) of at least one stabilizer, 1 to 10 phr (or 2 to 8 phr) of at least one zeolite, 0 to 10 phr (or 0 to 6 phr) of at least one antimony compound and/or zinc compound, wherein the total amount of active filler, antimony compound and/or zinc compound and zeolite in the flame retardant composition is less than or equal to about 50 phr (or about 40 phr) and the ratio of the total weight of active filler, antimony compound and zinc compound to the weight of zeolite is in a range from 0 to 10. In one embodiment, the flame retardant composition contains not more than 2.5 phr antimony compound and/or zinc compound. In another embodiment, the flame retardant composition is free or essentially free of any antimony compounds and any zinc compounds. The flame retardant composition may be characterized as being free, or essentially free, of any halogenated organic flame retardant compound.

In another embodiment of the invention, the flame retardant composition is comprised of, consists essentially of, or consists or at least one styrene-butadiene rubber (which can initially be in the form of a latex in an aqueous medium), 25 to 35 phr (or 28 to 32 phr) of aluminum trihydrate, 2 to 6 phr of at least one zeolite, 5 to 15 phr of at least one halogenated organic flame retardant compound, and optionally 0 to 3 phr of at least one antimony compound, wherein the total amount of antimony compound and zeolite in the flame retardant composition is less than or equal to about 6 phr and the ratio of the weight of antimony compound to the weight of zeolite is in a range from 0 to about 1.1.

### INDUSTRIAL APPLICABILITY

The flame retardant composition (or a precursor thereof) may be applied to a surface of a substrate by any conventional method, for example, by brushing, roll coating, spraying, dipping, extrusion, troweling or the like. The entire surface of the substrate or only a portion thereof in some preselected pattern may be coated with a layer of the flame retardant composition. The thickness of the applied coating may be varied as desired depending upon the particular end-use application, but typically will be from about 1 to about 50 microns. Where the substrate is porous or otherwise contains openings, the flame retardant composition may penetrate into such pores or openings. If the coating as applied contains water or other volatile materials (for example, where the organic polymer is supplied in the form of a latex) or contains a plastisol, the coated substrate may be dried in an oven or by other means to obtain a “cured” coating of the flame retardant composition.

The flame retardant composition may also be utilized as an adhesive to bond a first substrate and a second substrate. For example, a layer of the flame retardant composition may be applied to a surface of a first substrate to form a coated first substrate. The surface of the coated first substrate bearing the flame retardant composition layer may then be brought into contact with a surface of a second substrate, with the flame retardant composition layer positioned between the first substrate and second substrate such that it can function as an adhesive. Where the flame retardant composition contains water or another volatile substance or where the organic polymer is initially in the form of a plastisol (which can assist in rendering the flame retardant composition capable of being more readily applied to the substrate surface), drying or “curing” of the flame retardant composition layer can be delayed until after the first and second substrates are joined, since the adhesion of the substrates may thereby be enhanced. Alternatively, where no volatile substances are present in the composition when initially applied to the first substrate surface, the flame retardant composition may be heated immediately before or while being brought into contact with the second substrate surface so as to soften the flame retardant composition layer to improve its ability to adhere to such second substrate surface upon cooling. Adhesion of the two substrates may be further improved by pressing together the substrates.

The coating of flame retardant composition may also function as a sealant, mastic, binder, caulk, putty or the like.

The present invention can be readily adapted for use in a wide variety of end use applications, e.g., in the fields of construction, transportation, telecommunications, utilities, marine, chemical, petroleum, manufacturing and military, the hygiene sector, the medical sector, the textile and clothing industry, automobile applications, packaging, pharmacy, electrical engineering, electronics and domestic appliances. For example, the article comprising the substrate having at least a partial coating of the flame retardant composition coated thereon can be a carpet (including carpet tile), a mat, a wall paper or other wall covering, a mattress cover or ticking, a curtain, a tent, an article of clothing, a furniture covering (e.g., upholstery), an automobile or other transportation vehicle interior covering material (e.g., a seat cover, headliner, or door panel covering), or the like.

The present invention is particularly useful in the manufacture of tufted pile carpets. Tufted pile carpets typically include a secondary backing forming their lower surface and a primary backing tufted with yarns forming their upper surface. The yarn used in forming the pile of a tufted carpet is typically made of fibers of any of a number of materials, e.g., nylon, acrylics, polypropylene, polyethylene, polyamides, polyesters, wool, cotton, rayon and the like. Primary backings for tufted pile carpets are typically woven or non-woven fabrics made of one or more natural or synthetic fibers or yarns, such as jute, wool, polypropylene, polyethylene, polyamides, polyesters, nylon and rayon. Films of synthetic materials, such as polypropylene, polyethylene and ethylene-propylene copolymers may also be used to form the primary backing. Secondary backings for tufted pile carpets are typically woven or non-woven fabrics made of one or more natural or synthetic fibers or yarns.

The flame retardant composition described herein may be utilized as an adhesive or binder to bond the primary backing and secondary backing together, especially where the organic polymer component is initially supplied in the form of a latex or plastisol. The flame retardant composition containing the latex or plastisol may be applied as a coating on the reverse side (i.e., the non-pile side) of the primary backing layer, and the primary backing layer and the secondary backing layer pressed together by rollers. The carpet is then passed through an oven to remove water (if present) and cure the latex or plastisol. The cured layer of flame retardant composition binds the tufted primary backing to the secondary backing.

The advantageous properties of this invention can be observed by reference to the following examples, which illustrate but do not limit the invention.

### EXAMPLES

GLOSSARY

| | |
|---|---|
| Decabrome | Decabromodiphenyl ethane |
| DIDP-E | Di-iso-decyl phthalate plasticizer, electrical grade |
| | (ExxonMobil Chemical, Houston, TX USA) |
| MARK 4712 | Barium zinc stabilizer (Chemtura, Middlebury, CT) |
| S-148 Plasticizer | Iso-decyldiphenyl phosphate |
| ONGARD ® 2 | Magnesium oxide (60%)/zinc oxide (40%) |
| | (Chemtura, Middlebury, CT) |
| PVC 1300N | Polyvinyl chloride (100% solids; prepared by |
| | suspension polymerization; K value = 75) |
| SBR | Styrene-butadiene rubber |

### Sample Evaluation

Limiting oxygen index: Limiting oxygen index (LOI) was determined by ASTM D2863. Limiting oxygen index is the minimum concentration of oxygen that will just support flaming combustion in a flowing mixture of oxygen and nitrogen. A specimen is positioned vertically in a transparent test column and a mixture of oxygen and nitrogen is forced upward through the column. The specimen is ignited at the top. The oxygen concentration is adjusted until the specimen just supports combustion. The concentration reported is the volume percent of oxygen at which the specimen just supports combustion.

FMVSS-302 (Federal Motor Vehicle Safety Standard-302): Any portion of a single or composite material that is within 0.5 in of the occupant compartment air space shall meet the requirements of FMVSS-302. The test is conducted in a test chamber in which a test specimen is mounted horizontally. The exposed side of the test specimen is subjected to a gas flame from underneath. The burn distance and the time taken to burn this distance are measured. To pass the test, a material shall not burn, nor transmit a flame front across its surface, at a rate of more than 4 in/min. If a material stops burning before it has burned for 1 min from the start of timing, and has not burned more than 2 in from the point where timing was started, it shall be considered to meet the burn-rate requirement of the standard.

Pill Test Procedure 1630: The flame retardant composition to be tested is mixed (an about 300 g batch) in a Waring blender. Carpet samples are cut in 9″×9″ squares (8 samples). The back of each carpet sample is coated with 70 g of a composition to be tested using a spatula. It is important to achieve a uniform coating. Samples are dried in a circulation oven for 2 hr at 105° C. Samples are then allowed to cool to room temperature in a desiccating cabinet and placed on the floor of a hood cabinet that is capable of being closed. A steel plate (9″×9″×¼″) with a 8-in diameter hole in its center is placed on the carpet, mainly to hold the carpet flat during the flame testing. A number 1588 methenamine timed burning tablet is placed in the center of the carpet, and lighted with a wood match. If the charred area extend less than one inch from the edge of the hole in the flattening frame the sample passes, otherwise it fails. Recording the length of the charred area allows an estimation of the flame retardance efficacy of the formulation.

Federal Aviation Regulation 25.853b (FAR25.853b): FAR25.853b is a vertical burn test. In this test, a 0.5″×3.0″×12″ long foam sample is mounted in a vertical position. The lower (0.5″×3.0″) end is exposed to a 1.5″ long Bunsen burner flame for 12 seconds. The time to flame extinguishment after removal of the Bunsen burner flame, and the burned length of the sample are recorded. If the sample exhibits an average flame time of less than 15 seconds and the char length is less than 8″, it shall be considered to pass the regulation requirements. In the examples reported below, this test procedure was carried out using samples measuring 20 mils×3.0″×12″ (a modification of FAR25.853b well accepted in the industry).

Smoke Index Test: This test is based on the smoke obscuration of a glass slide positioned in the effluent stream of a conventional limiting oxygen index (LOI) testing apparatus. The LOI of each sample is determined prior to proceeding with the smoke index test. A sample measuring 5″ long by ⅛″ thick by ¼″ wide is placed in the holder in accordance with LOI ASTM testing procedures. The recorder and light source are turned on and adjusted so that when no light is transmitted through the glass slide the recorder reads zero. The oxygen and nitrogen flow meters are set at the setting that the sample last burned at during the LOI testing and allowed to flow for 30 seconds. With the ventilating hood off, the sample is lighted and the smoke density attachment is placed on top of the glass column. The recorder is started and the sample is allowed to burn for one minute. The data are collected and averaged. The glass slides are cleaned before the next sample is tested.

### Example 1

This example shows the use of zeolite as an antimony oxide replacement in a PVC latex. The formulation evaluated is similar to those in PVC coated fabrics, which are used in automotive applications.

| | Concentration (%) | | | |
|---|---|---|---|---|
| | Control | Ex 1-1 | Ex 1-2 | Ex 1-3 |
| Ingredient | | | | |
| PVC 1300N (Suspension) | 47.9 | 46.9 | 47.9 | 47.9 |
| DIDP-E | 31.0 | 31.0 | 31.0 | 31.0 |
| Calcium carbonate | 15.0 | 15.0 | 15.0 | 15.0 |
| MARK-4712 Stabilizer | 1.5 | 1.5 | 1.5 | 1.5 |
| Epoxidized Soybean Oil | 2.5 | 2.5 | 2.5 | 2.5 |
| Stearic acid | 0.1 | 0.1 | 0.1 | 0.1 |
| Antimony Oxide | 2.0 | — | — | 1.0 |
| Synthetic Zeolite | — | 3.0 | 2.0 | 1.0 |
| Total | 100.0 | 100.0 | 100.0 | 100.0 |
| Test Results | | | | |
| FMVSS-302 | Pass | Fail | Fail | Pass |
| LOI, % | 26 | 22 | 22 | 24 |
| Smoke Index (100 = no smoke) | 52 | 74 | 64 | 63 |

### Example 2

This example shows the use of zeolite as a zinc replacement in a PVC latex containing composition useful for producing PVC coated fabric for mass transit applications.

| | Concentration (%) | | |
|---|---|---|---|
| | Control | Ex 2-1 | Ex 2-2 |
| Ingredient | | | |
| PVC 1300N (Suspension) | 46.9 | 46.9 | 46.9 |
| S-148 Phosphate Plasticizer | 26.0 | 26.0 | 26.0 |
| Aluminum trihydrate | 13.5 | 13.5 | 13.5 |
| DIDP-E | 8.0 | 8.0 | 8.0 |
| MARK-4712 Stabilizer | 1.5 | 1.5 | 1.5 |
| Epoxidized Soybean Oil | 2.0 | 2.0 | 2.0 |
| Stearic acid | 0.1 | 0.1 | 0.1 |
| ONGARD ® 2 | 2.0 | 1.0 | — |
| Natural Zeolite | — | 1.0 | 2.0 |
| Total | 100.0 | 100.0 | 100.0 |
| Test Results | | | |
| FAR25.853b | Pass | Pass | Pass |
| LOI, % | 25 | 27 | 27 |
| Smoke Index (100 = no smoke) | 90 | 80 | 72 |

### Example 3

Example 3 illustrates flame retardant compositions that may be used to coat substrates to provide articles in accordance with the present invention.

| | INGREDIENT (%) | | | | | | |
|---|---|---|---|---|---|---|---|
| Ingredient | Control | #3-1 | #3-2 | #3-3 | #3-4 | #3-5 | #3-6 |
| SBR Latex (68% | 100 | 100 | 100 | 100 | 100 | 100 | 100 |
| Solids) | | | | | | | |
| Aluminum | 20 | 20 | 20 | 20 | 20 | 20 | 20 |
| trihydrate | | | | | | | |
| Decabrome | 6.6 | 6.6 | 6.6 | 6.6 | 6.6 | 6.6 | 6.6 |
| Antimony oxide | 3.3 | | 1 | 1.7 | | 1 | 1.7 |
| Natural Zeolite | | 3.3 | 2.3 | 1.7 | | | |
| Synthetic Zeolite | | | | | 3.3 | 2.3 | 1.7 |
| Total Ingredients | 129.9 | 129.9 | 129.9 | 130 | 129.9 | 129.9 | 130 |
| Pill Test 1630 | Pass | Pass | Pass | Pass | Pass | Pass | Pass |
| Length of Char | 3¼″ | 3¼″ | 3¼″ | 3″ | 3¼″ | 3¼″ | 3¼″ |

Having described the invention, we now claim the following and their equivalents.

What is claimed is:

1. An article comprising a substrate and a flame retardant composition, wherein the flame retardant composition comprises:
at least one organic polymer;
at least one zeolite;
at least one filler, which may optionally include at least one active filler;
optionally, at least one antimony compound, brominated compound, and/or zinc compound;
in which:
the total amount of active filler, antimony compound, brominated compound, zinc compound and zeolite in the composition is less than or equal to about 50 phr; and
the ratio of the total weight of antimony compound, brominated compound and zinc compound to the weight of zeolite is in a range from 0 to about 10.

2. The article of claim 1, wherein said substrate has at least one surface with at least a partial coating of said flame retardant composition thereon.

3. The article of claim 1, wherein said at least one organic polymer includes a halogenated organic polymer.

4. The article of claim 1, wherein said at least one organic polymer includes a non-halogenated organic polymer.

5. The article of claim 1, wherein said at least one organic polymer includes a rubber.

6. The article of claim 1, wherein said at least one organic polymer includes at least one styrene-butadiene rubber.

7. The article of claim 1, wherein said at least one zeolite is not a metal ion-exchanged zeolite or an adduct with an inorganic halide.

8. The article of claim 1, wherein said flame retardant composition passes at least one test selected from FMVSS-302, FAR25.853b, or Pill Test 1630.

9. The article of claim 1, wherein said flame retardant composition additionally comprises at least one halogenated organic flame retardant.

10. The article of claim 1, wherein said flame retardant composition additionally comprises decabrome.

11. The article of claim 1, wherein said flame retardant composition is free of antimony compounds.

12. The article of claim 1, wherein said at least one filler includes at least one of calcium carbonate or a hydrated metal oxide.

13. The article of claim 1, wherein said flame retardant composition is comprised of at least 2 phr zeolite but not more than 3 phr antimony compound.

14. The article of claim 1, wherein the ratio of the weight of antimony compound to the weight of zeolite does not exceed 2.

15. The article of claim 1, wherein said substrate is flexible.

16. The article of claim 1, wherein said substrate is rigid.

17. The article of claim 1, wherein said substrate is a fabric.

18. The article of claim 1, wherein said at least one organic polymer includes a polyvinyl chloride.

19. The article of claim 1, wherein said flame retardant composition is comprised of at least one styrene-butadiene rubber, 25 to 35 phr of aluminum trihydrate, 2 to 6 phr of at least one zeolite, 5 to 15 phr of at least one non-polymeric halogenated organic flame retardant compound, and optionally 0 to 3 phr of at least one antimony compound, wherein the total amount of antimony compound and zeolite in the flame retardant composition is less than or equal to about 6 phr and the ratio of the weight of antimony compound to the weight of zeolite is in a range from 0 to about 1.1.

20. The article of claim 1, wherein said flame retardant composition is comprised of at least one polyvinyl chloride, 60 to 80 phr of at least one plasticizer, 5 to 12 phr of at least one stabilizer, 20 to 40 phr of at least one inorganic particulate filler, which may optionally include at least one active filler, 2 to 8 phr of at least one zeolite, 0 to 6 phr of at least one flame retardant compound selected from the group consisting of antimony compounds and zinc compounds, wherein the total amount of flame retardant compound and zeolite in the flame retardant composition is less than or equal to about 10 phr, the ratio of the total weight of active filler and flame retardant to the weight of zeolite is in the range from 0 to 10, and the amount by weight of flame retardant compound does not exceed the amount by weight of zeolite.

21. A method of making a coated substrate, said method comprising applying a coating of a flame retardant composition onto at least a portion of at least one surface of a substrate, wherein the flame retardant composition comprises:
at least one organic polymer;
at least one zeolite;
at least one filler, optionally including at least one active filler;
optionally, at least one antimony compound, brominated compound, and/or zinc compound;
in which:
the total amount of active filler, antimony compound, brominated compound, zinc compound and zeolite in the composition is less than or equal to about 50 phr; and
the ratio of the total weight of antimony compound, brominated compound and zinc compound to the weight of zeolite is in a range from 0 to about 10.

22. A method of adhering a first substrate to a second substrate, said method comprising applying a coating of a flame retardant composition onto at least a portion of at least one surface of at least one of said first substrate or said second substrate to obtain a coated substrate and bringing said coating into contact with at least a portion of at least one surface of the other of said first substrate or said second substrate such that said coating is positioned between said first substrate and said second substrate, wherein the flame retardant composition comprises:
at least one organic polymer;
at least one zeolite;
at least one filler, optionally including at least one active filler;
optionally, at least one antimony compound, brominated compound, and/or zinc compound;
in which:
the total amount of active filler, antimony compound, brominated compound, zinc compound and zeolite in the flame retardant composition is less than or equal to about 50 phr; and
the ratio of the total weight of antimony compound, brominated compound and zinc compound to the weight of zeolite is in a range from 0 to about 10.
